(19) United States
(12) Patent Application Publication
(10) Pub. No.: US 2005/0151441 A1
(43) Pub. Date: Jul. 14, 2005

(54) Commutator, and electrical motor and fluid pump using the same

(75) Inventors: Motoya Ito, Hekinan-city (JP); Keiichi Yamashita, Kariya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Kariya-city (JP)

(21) Appl. No.: 11/028,558

(22) Filed: Jan. 5, 2005

(30) Foreign Application Priority Data
Jan. 14, 2004 (JP) 2004-6971

(51) Int. Cl. H02K 5/10; H02K 5/12

(52) U.S. Cl. 310/234; 310/237; 310/87; 310/43

(57) ABSTRACT

A commutator includes plural segments arranged in a rotational direction, and segment terminals electrically connected to respective segments. The segment terminals include middle terminals and end terminal portions, and the segments are electrically connected to the end terminal portions through middle terminal portions. The segments, the middle terminals and the end terminal portions are supported by a resin material made of a thermoplastic resin. By electrically connecting the end terminal portions of the commutator and coil terminals of an armature, the segments of the commutator and coils of the armature can be electrically connected. An electrical motor can be provided with the commutator and the armature. Further, this structure of the electrical motor can be suitably used for a fluid pump such as a fuel pump.

### CROSS REFERENCE TO RELATED APPLICATION

This application is based on Japanese Patent Application No. 2004-006971 filed on Jan. 14, 2004, the contents of which are incorporated herein by reference.

### FIELD OF THE INVENTION

The present invention relates to a commutator having segments electrically connected to coils of an armature by contacting its terminals, and an electrical motor and a fluid pump such as a fuel pump using the commutator.

### BACKGROUND OF THE INVENTION

In a conventional commutator described in JP-A-7-161428, plural segments arranged in a rotational direction and segment terminals electrically connected to respective segments are supported by a resin material. Further, each coil of an armature is bound to each of the segment terminals so that each segment of the commutator and each coil of the armature are electrically connected by fusing. When the segment terminals and the coils of the armature are electrically connected by the fusing, a thermosetting resin is used as the resin material of the commutator in order to prevent the resin material of the commutator from being softened by heat generated during fusing.

However, when the thermosetting resin is used as the resin material of the commutator, because the resin is hardened by increasing its temperature during molding, the manufacturing time becomes longer. Further, once the thermosetting resin is hardened, it is difficult to change the hardened shape and it is also difficult to dissolve in a solvent. Therefore, an extra resin material generated and cut in the molding cannot be reused. Accordingly, the manufacturing cost of the commutator increases.

### SUMMARY OF THE INVENTION

In view of the above-described problems, it is an object of the present invention to provide a commutator which can be manufactured at a low cost in a short time.

It is another object of the present invention to provide an electrical motor and a fluid pump such as a fuel pump using the commutator.

According to the present invention, a commutator includes a plurality of segments arranged in a rotational direction to contact a brush, a plurality of segment terminals which are electrically connected to respective segments, and a resin material disposed to support the segments and the segment terminals. In the commutator, the segments are electrically connected to coils of an armature by contacting coil terminals of the armature and the segment terminals.

Accordingly, it is unnecessary to perform a heating process such as a fusing in order to electrically connect the coils of the armature and the segments of the commutator. Because the resin material for supporting the segments and the segment terminals is not heated when the segments of the commutator and the coils of the armature are electrically connected, a thermoplastic resin can be used as the resin material. As a result, a manufacturing time for the commutator can be made shorter compared with a case where a thermosetting resin is used as the resin material. Furthermore, a surplus resin material generated during the resin molding can be easily reused, and the manufacturing cost of the commutator can be reduced.

Preferably, each of the segments has a contact surface which the brush contacts, and the contact surface of each segment has a recess portion between an outer peripheral edge and an inner peripheral edge of each segment in a radial direction. Accordingly, even when the recess portion is formed by cutting, it can prevent the resin material from being softened due to heat during the cutting.

More preferably, each segment terminal has a terminal portion protruding to a side of the coils of the armature, and the segments are electrically connected to the coils of the armature by inserting the terminal portion of each segment terminal into an insertion portion of each coil terminal. Therefore, the electrical connection between the segments and the coils of the armature can be readily performed. For example, each segment terminal further includes a middle terminal through which each segment is electrically connected to the terminal portion of each segment terminal.

Furthermore, the resin material can be disposed to support an inner peripheral wall and an outer peripheral wall of each segment in a radial direction.

The commutator of the present invention can be suitably used for an electrical motor including the armature and a magnetic member having a plurality of magnetic poles arranged circumferentially around the armature. In addition, the electrical motor having the commutator can be suitably used for a fluid pump such as a fuel pump.

### BRIEF DESCRIPTION OF THE DRAWINGS

Other objects, features and advantages of the present invention will become more apparent from the following detailed description made with reference to the accompanying drawings, in which:

FIG. 1 is a cross-sectional view showing a fuel pump according to a preferred embodiment of the present invention;

FIG. 2 is a cross-sectional view showing a rotor in the fuel pump;

FIG. 3 is a cross-sectional view taken along line III-III in FIG. 1; and

FIG. 4 is an enlarged view of a segment of a commutator according to the preferred embodiment.

### DETAILED DESCRIPTION OF THE PREFERRED EMBODIMENT

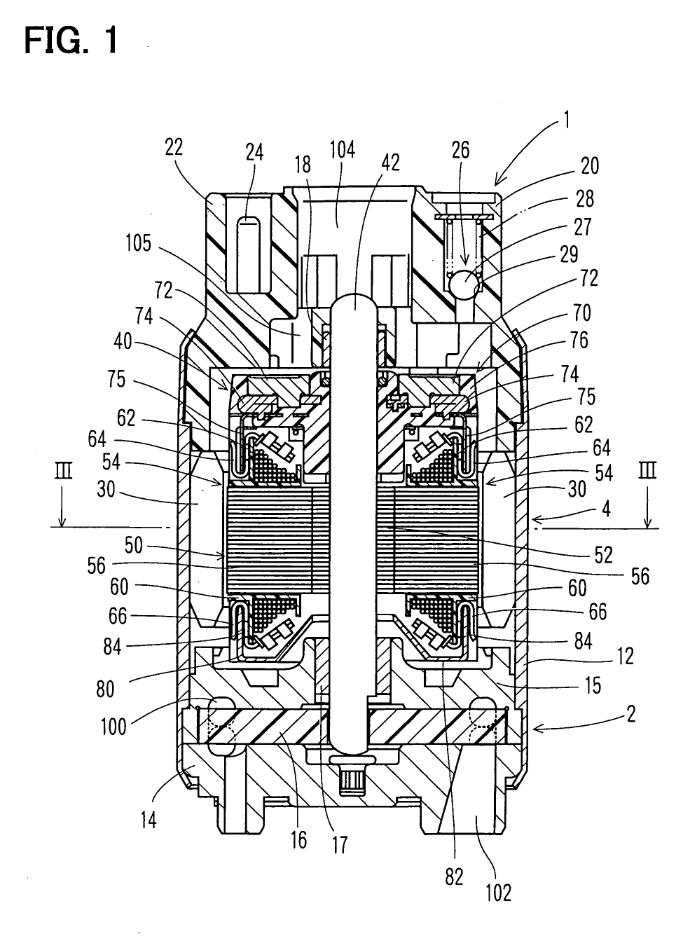

A preferred embodiment of the present invention will be now described with reference to FIGS. 1-4. FIG. 1 shows a fuel pump 1 having an electrical motor 4 using a commutator 70 of the present invention. For example, the fuel pump 1 is an in-tank pump that is mounted in a fuel tank of a vehicle to supply fuel in the fuel tank to a fuel consumption system such as an engine. The fuel pump 1 includes a pump portion 2 for increasing pressure of a drawn fuel, and an electrical motor 4 for driving the pump portion 2 by rotating a rotor 40 around a shaft 42. The pump portion 2 includes an intake side cover 14, an impeller casing 15 and a circular impeller 16. The electrical motor 4 is constructed with a direct current motor, and is provided with permanent magnets 30 and the rotor 40.

A housing 12 of the fuel pump 1 fastens the intake side cover 14 and a discharge side cover 20, which are disposed at two end sides of the shaft 42 of the rotor 40. The intake side cover 14 and the impeller casing 15 are used as a pump casing, and are disposed to accommodate the impeller 16. A C-shaped pump passage 100 is formed between the intake side cover 14 and the impeller casing 15. The impeller casing 15 is disposed opposite to the rotor 40 in an axial direction of the shaft 42, and supports a bearing member 17 at an inner peripheral side of the impeller casing 15.

Multiple impeller grooves are formed on an outer periphery of the circular impeller 16. When the impeller 16 rotates together with the shaft 42 by the rotation of the rotor 40, a pressure differential is generated at front and back of the impeller groove of the impeller 16 due to a fluid frictional force. By repeating this operation at the multiple impeller grooves, the fuel in the pump passage 100 is pressurized. The fuel in the fuel tank is drawn into the fuel passage 100 from a fuel intake port 102 formed in the intake side cover 14, and is discharged from the impeller casing 15 to a side of a cover structure member 80. The cover structure member 80 is formed into a single member from a metal, and is positioned opposite to the commutator 70 of the rotor 40. The fuel from the cover structure member 80 flows toward the commutator 70 through an outer periphery of the rotor 40, and flows to a fuel discharge port 104 through communication paths 105 that are provided in the discharge side cover 20 at four points to enclose the periphery of the shaft 42. Then, the fuel is supplied from the fuel pump 1 to the engine through the fuel discharge port 104.

The discharge side cover 20 is made of resin, and is formed to cover the commutator 70 of the electrical motor 4. The fuel discharge port 104 is formed approximately at a center portion of the discharge side cover 20 on the axial line of the shaft 42. A receiving connector 22 is formed at an outer peripheral end portion of the discharge side cover 20, offset from the center portion of the discharge side cover 20. A terminal 24 press-fitted into the discharge side cover 20 is arranged inside the receiving connector 22. A pressure adjustment valve 26 for adjusting the pressure inside the fuel pump 1 is provided within the discharge side cover 20. The pressure adjustment valve 26 includes a ball 27, a spring 28 for biasing the ball 27 at one side, and a valve seat 29 on which the ball 27 can be seated. When the pressure within the fuel pump 1 becomes larger than a predetermined pressure, the ball 27 separates from the valve seat 29 opposite to the biasing force of the spring 28, so that the pressure within the fuel pump 1 is decreased.

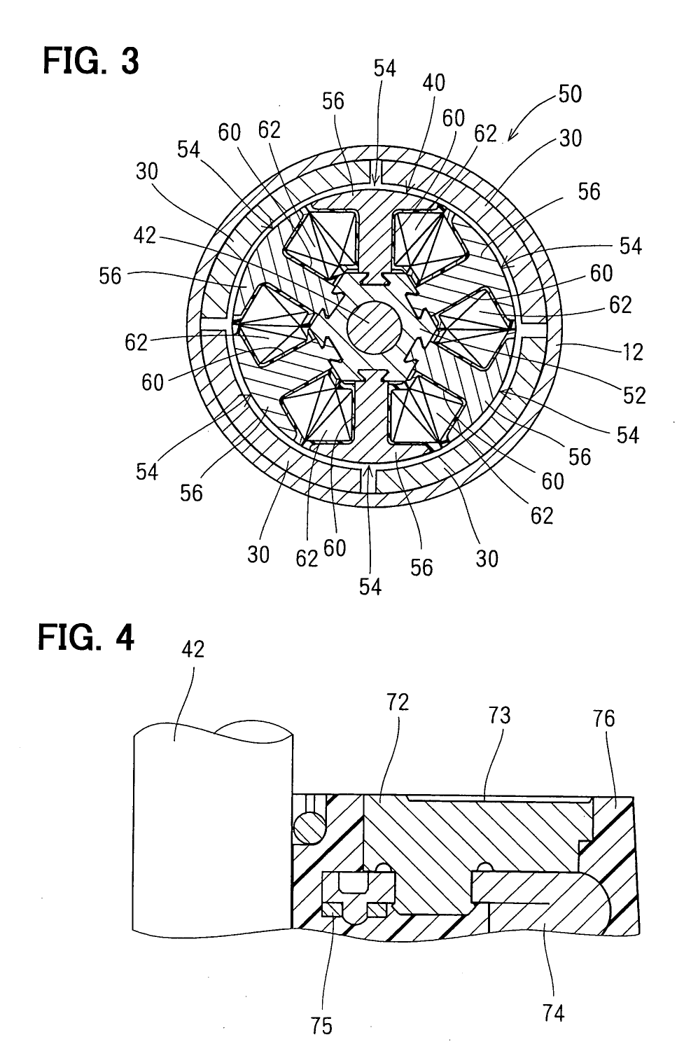

Four permanent magnets 30 each of which is formed in a quarter circular arc shape are arranged in a circumferential direction, and are attached to an inner peripheral wall of the housing 12 (FIG. 3). The permanent magnets 30 are constructed with four magnetic poles having different poles in the rotational direction.

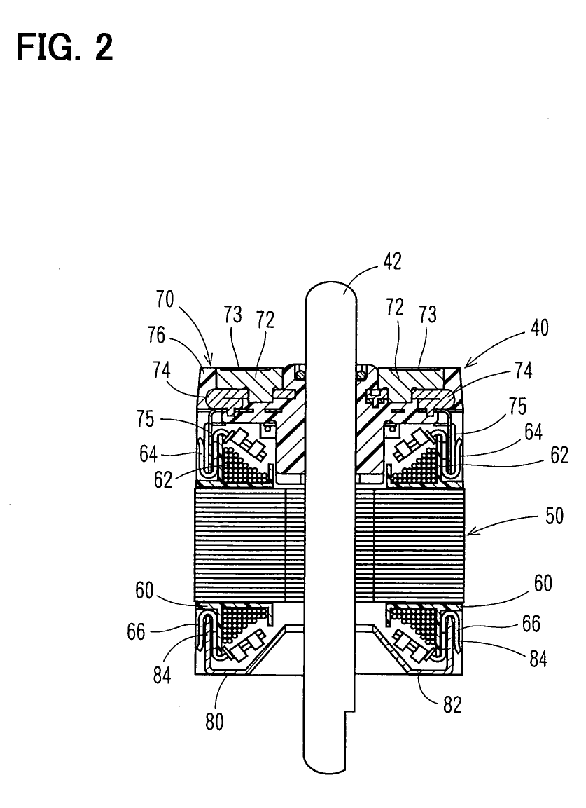

As shown in FIG. 2, the rotor 40 includes an armature 50, the commutator 70 and the cover structure member 80. The commutator 70 is disposed at one side of the armature 50 in the axial direction, and the cover structure member 80 is provided to cover the other side of the armature 5 opposite to the commutator 70. Further, as shown in FIG. 1, the shaft 42 of the rotor 40 is rotatably supported in bearing members 17, 18, which are supported in the impeller casing 15 and the discharge side cover 20, respectively.

As shown in FIG. 3, the armature 50 has a center core 52 at its rotation center portion, and the shaft 42 is press-fitted into the center core 52. Plural magnetic pole coil portions 54 (e.g., six magnetic pole coil portions) are arranged in the rotational direction at an outer periphery of the center core 52 to be connected to the center core 52. Each of the magnetic pole coil portions 54 includes a coil core 56, a bobbin 60 and a coil 62. The coil 62 is formed by collectively winding wires on the bobbin 60. In this embodiment, the six magnetic pole coil portions 54 have the same structure.

Furthermore, an end portion of each coil 62 at a side of the commutator 70 is electrically connected to a coil terminal 64. Because the coil terminals 64 are positioned slightly inside an outer peripheral surface of the armature 50, it can prevent resistance to the fuel flowing on the outer periphery of the armature 50 from being increased due to the arrangement of the coil terminals 64. The coil terminals 64 contact terminals 75 of the commutator 70 to be electrically connected to the terminals 75. In this embodiment, each of the terminals 75 protrudes toward the coil terminals 64 of the armature 50, and each of the coil terminals 64 has an insertion portion. By inserting the terminals 75 into the insertion portions of the coil terminals 64, the segments 72 are electrically connected to the coils 62. In this embodiment, each of the insertion portions of the coil terminals 64 is formed approximately in a U shape, and the terminals 75 extend in the axial direction. Therefore, the terminals 75 are readily inserted into the insertion portions of the coil terminals 64.

End portions of the coils 62 at the side of the cover structure member 80 are electrically connected to six terminals 66 that are arranged continuously in the rotation direction. Furthermore, the six terminals 66 are electrically connected to the cover structure member 80.

The commutator 70 is an integrally formed cassette type. The commutator 70 has plural segments 72 (e.g., six segments in this embodiment) arranged in the rotational direction. For example, the segments 72 are formed of carbon. Segments 72 adjacent to each other in the rotational direction are electrically insulated from each other by clearances (not shown) and resin materials 76 arranged between the adjacent segments 72. The segments 72 are electrically connected to the terminals 75 through middle terminals 74. Each terminal 75 is arranged to electrically connect two segments 72 positioned opposite in a radial direction.

In this embodiment, the middle terminals 74 and the terminals 75 construct segment terminals of the present invention. The segments 72, the middle terminals 74 and the terminals 75 are supported by the resin material 76. The resin material 76 is a thermoplastic insulation resin, and is superior in an oil resistance. For example, as the thermoplastic insulation resin, polyphenylensulfide (PPS), polyoxymethylene (POM), polyether-etherketone (PEEK), liquid crystal polymer (LCP), polyetherimide (PEI) or polyether sulfone (PES) can be used.

As shown in FIG. 4, a recess portion 73 is provided on a brush-contacting surface of each segment 72, to be recessed from the brush-contacting surface toward the inner side (i.e., the side of the terminals 74, 75) between an outer peripheral edge and an inner peripheral edge of the segment 72. The recess portion 73 is not provided on the resin material 76 positioned at the inner peripheral side and the outer peripheral side of each segment 72. When the armature 50 rotates, the recess portions 73 of the segments 72 contact the brush (not shown) in order.

The cover structure member 80 includes a circular cover 82 and plural terminals 84 (e.g., six in this embodiment). The cover structure member 80 is formed into a single member from a metal material plated with tin on brass. The six terminals 84 are arranged at six positions in a circumferential direction of the cover 82 to protrude from the cover 82 toward the armature 50. The six terminals 84 are electrically connected with each other through the cover 82. The terminals 84 of the cover structure member 80 are fitted into the terminals 66 of the armature 50, so that end portions of the coils 62 on the side of the cover structure member 80 are electrically connected with each other. In this embodiment, each terminal 84 of the cover structure member 80 protrudes to the side of the commutator 70, and each terminal 66 of the armature 50 has an insertion portion. Therefore, by inserting the terminals 84 of the cover structure member 80 into the insertion portions of the terminals 66 of the armature 50, the end portions of the coils 62 on the side of the cover structure member 80 can be readily electrically connected with each other.

Next, a method for manufacturing the commutator 70 will be described. Firstly, base materials of the segments 72, the middle terminals 74 and the terminals 75 are assembled, and an insert molding is performed by using the resin material 76. Then, the recess portion 73 is formed on the brush-contacting surface of the base material of each segment 72 between the outer peripheral edge and the inner peripheral edge of the base material of each segment 72, at a position spaced from the resin material 76. Thereafter, the base material is cut to be divided into the six segments 72 which are supported in the resin material 76.

According to this embodiment, the terminals 75 of the commutator 70 and the coil terminals 64 of the armature 50 contact so as to be electrically connected with each other, so that the segments 72 of the commutator 70 and the coils 62 of the armature 50 are electrically connected. Therefore, when the segments 72 of the commutator 70 and the coils 62 of the armature 50 are electrically connected, the resin material 76 is not heated. As a result, a thermoplastic resin can be used as the resin material 76, and a resin molding time of the resin material 76 can be made shorter compared with a case where the resin material 76 is made from a thermosetting resin. Further, because the thermoplastic resin is used as the resin material 76, surplus resin material generated during the molding of the resin material 76 can be effectively reused by melting, for example. Accordingly, the manufacturing cost of the resin material 76 can be effectively reduced.

In this embodiment, the terminal 75 of each segment 72 protrudes to a side of the coil terminal 64, and the coil terminal 64 of each coil 62 of the armature 50 is formed to have an insertion portion. Therefore, by inserting the terminal 75 of each segment 72 of the commutator 70 into the insertion portion of the coil terminal 64 of each coil 62, the segments 72 of the commutator 70 and the coils 62 of the armature 50 can be readily electrically connected.

Although the present invention has been fully described in connection with the preferred embodiment thereof with reference to the accompanying drawings, it is to be noted that various changes and modifications will become apparent to those skilled in the art.

For example, in the above-described embodiment, the brush contacting surface of each segment 72 between the inner peripheral edge and the outer peripheral edge of each segment 72 in the radial direction is cut to form the recess portion 73 at a position except for the resin material 76. However, an entire brush contacting surface of the commutator 70, including the segments 72 and the resin material 76, can be cut to form the recess portion 73, depending on the melting temperature of the thermoplastic resin.

Furthermore, the present invention can be applied to a commutator for another use, without being limited to the electrical motor of the fuel pump. For example, the commutator 70 of the present invention can be used for a fluid pump for pumping a fluid.

Such changes and modifications are to be understood as being within the scope of the present invention as defined by the appended claims.

1. A commutator comprising:
a plurality of segments arranged in a rotational direction to contact a brush;
a plurality of segment terminals which are electrically connected to respective segments; and
a resin material disposed to support the segments and the segment terminals, wherein:
the segments are electrically connected to coils of an armature by contacting coil terminals of the armature and the segment terminals; and
the resin material is a thermoplastic resin.

2. The commutator according to claim 1, wherein:
each of the segments has a contact surface on which the brush contacts; and
the contact surface of each segment has a recess portion between an outer peripheral edge and an inner peripheral edge of each segment in a radial direction.

3. The commutator according to claim 1, wherein:
each segment terminal has a terminal portion protruding to a side of the coil terminals of the armature; and
the segments are electrically connected to the coils of the armature by inserting the terminal portion of each segment terminal into an insertion portion of each coil terminal.

4. The commutator according to claim 3, wherein each segment terminal further includes a middle terminal through which each segment is electrically connected to the terminal portion of each segment terminal.

5. The commutator according to claim 1, wherein the resin material is disposed to support an inner peripheral wall and an outer peripheral wall of each segment in a radial direction.

6. The commutator according to claim 3, wherein:
the insertion portion of each coil terminal has approximately a U shape; and
the terminal portion of each segment terminal extends in an axial direction of the armature.

7. An electrical motor comprising:
a commutator which includes a plurality of segments arranged in a rotational direction to contact a brush, a plurality of segment terminals which are electrically connected to respective segments, and a resin material disposed to support the segments and the segment terminals;
an armature rotatably arranged around a shaft, the armature including a plurality of coils arranged in the rotational direction, and a plurality of coil terminals electrically connected to respective coils; and
a magnetic member including a plurality of magnetic poles arranged circumferentially around the armature,
wherein the segments are electrically connected to the coils by contacting the coil terminals of the armature and the segment terminals.

8. The electrical motor according to claim 7, wherein the resin material is a thermoplastic resin.

9. The electrical motor according to claim 7, wherein:
each of the segments has a contact surface on which the brush contacts; and
the contact surface of each segment has a recess portion between an outer peripheral edge and an inner peripheral edge of each segment in a radial direction.

10. The electrical motor according to claim 7, wherein:
each segment terminal has a terminal portion protruding to a side of the coil terminal; and
the segments are electrically connected to the coils of the armature by inserting the terminal portion of each segment terminal into an insertion portion of each coil terminal.

11. The electrical motor according to claim 10, wherein:
the terminal portion of each segment protrudes in an axial direction of the shaft; and
the insertion portion of each coil terminal has approximately a U-shape.

12. The electrical motor according to claim 7, wherein the coil terminals are arranged inside an outer peripheral surface of the armature.

13. The electrical motor according to claim 7, wherein the electrical motor is used for a fuel pump which generates an intake force for drawing a fuel in a fuel tank by a rotation driving force of the electrical motor.

14. A fluid pump for pumping a fluid by using a drive force of an electrical motor, the electrical motor comprising:
a commutator which includes a plurality of segments arranged in a rotational direction to contact a brush, a plurality of segment terminals which are electrically connected to respective segments, and a resin material disposed to support the segments and the segment terminals;
an armature rotatably arranged around a shaft, the armature including a plurality of coils arranged in the rotational direction, and a plurality of coil terminals electrically connected to respective coils; and
a magnetic member including a plurality of magnetic poles arranged circumferentially around the armature,
wherein the segments are electrically connected to the coils by contacting the coil terminals of the armature and respective the segment terminals.

15. The fluid pump according to claim 14, wherein the resin material is a thermoplastic resin.
